(19) United States
(12) Patent Application Publication
(10) Pub. No.: US 2006/0072900 A1
(43) Pub. Date: Apr. 6, 2006

(54) Method and apparatus for storing a stream of data received from a source

(75) Inventors: Liang Gan, Shanghai (CN); Jingwei Tan, Shanghai (CN); Declan Patrick Kelly, Eindhoven (NL); Jun Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/537,136

(22) PCT Filed: Nov. 28, 2003
(86) PCT No.: PCT/IB03/05540

§ 371 Date: Jun. 2, 2005

(30) Foreign Application Priority Data
Dec. 20, 2002 (EP) 02080536.2

(51) Int. Cl. H04N 5/783; H04N 5/781

(52) U.S. Cl. 386/68; 386/125

(57) ABSTRACT

State-of-the art video recorders are equipped with a pause function. This function may be used in the play and record mode. When used in the record mode, no data is recorded. This is all right when only audio and/or video are recorded. However, when other data like interactive applications are recorded as well, this may lead to problems when the recording of an application is interrupted and this application is called upon in a video fragment that is recorded after resuming recording of audio and/or video. The invention has the following object. When the record function is suspended, using a pause function, only recording of audio and/or video is suspended and recording of other data is continued.

The invention relates to a method of storing a stream of data received from a source in a memory, the stream of data comprising a stream of audio-visual data and other data, the method comprising the steps of storing the stream of data in a memory and receiving a pause command.

The invention further relates to an apparatus for storing a stream of data received from a source in a memory, the stream of data comprising a stream of audio-visual data and other data, the apparatus comprising: means for receiving a memory to store the stream of data; means for receiving a pause command; and a central processing unit.

The invention also relates to a programmed computer.

Embodiments of such a method and apparatus are known from U.S. Pat. No. 6,404,977. This document discloses a video recorder that comprises an automatic pause function. The automatic pause function is triggered upon detection of a commercial. Upon receiving the pause command, recording of all incoming data is halted. In this way, a stream of video data is recorded that does not comprise commercial breaks.

When only video data is received and recorded, this is no problem. However, when additional data is received and recorded with the video data—other data like data related to interactive applications as can be provided with the multimedia home platform protocol—this may lead to problems.

For example, during the commercial break, data for an application may be broadcast, an application of which the execution is signalled right after the commercial break. When the data is not recorded—because the recording of all incoming data was halted—this causes problems, because during replay of recorded data, the data for the signalled application does not appear to be present.

It is an object of the invention to ensure that all data of applications that are triggered to run during reproduction of the stored audio-visual data is stored during recording of the audio-visual data.

This object is achieved with the method according to the invention, and is characterized in that that the method further comprises the steps of pausing the storage of the stream of audio-visual data upon reception of the pause command; and continuing the storage of the other data

By continuing the recording of other data, it is ensured that all data of applications triggered (or signalled) to be executed during reproduction of the recorded data is stored.

In an embodiment of the method according to the invention, the other data comprises interactive applications that use trigger points in the stream of audio-visual data as input and the method further comprises the steps of receiving an unpause command; re-commencing the storage of the stream of audio-visual data upon reception of the unpause command; and shifting at least one trigger point that is present in the stream of audio-visual data that is received while storage of the stream of audio-visual data is paused towards a point in the stream of audio-visual data that will be stored after re-commencing the storage of the stream of audio-visual data.

During reproduction of a received stream of audio-visual data like a television broadcast programme, multiple application may be executed. The output of some of the different applications may be used as input for further applications. When storage of a stream of audio-visual data is interrupted, it may occur that points at which applications are triggered to be run are not recorded. This means that they will not be executed upon reproduction of the stored data. When these applications create output, necessary as input for the further applications that are run during the reproduction, this may lead to inconsistency problems of the further applications.

By shifting the point at which applications are triggered from a location in the audio-visual data that is not stored to a location that is stored, the applications of which the output is necessary for the execution of the further applications are executed. In this way, consistency of the applications related to the stored audio-visual data is guaranteed, which is a great advantage of this embodiment of the invention.

In a further embodiment of the invention, the other data comprises interactive applications that are run during reproduction of the stream of audio-visual data and the method further comprises the step of deleting applications that are not run during reproduction of the stream of audio-visual data that is stored in the memory.

When the trigger point for an application is not recorded and the application is signalled only once at that specific trigger point, the application will not be signalled during reproduction of the stored stream of audio-visual data, and, consequently, the application will not be run during reproduction of the stored audio-visual data. Therefore, storage of the application has no useful meaning and the application can be deleted.

The apparatus according to the invention is characterized in that the central processing unit is conceived to pause a process of storing the stream of audio-visual data upon reception of a pause command and continue the storage of the other data while the process of storing the stream of audio-visual data is paused.

The programmed computer according to the invention is characterized in that the computer is programmed to perform the method defined in claim 1.

These and other aspects of the invention will be elucidated by means of Figures, wherein:

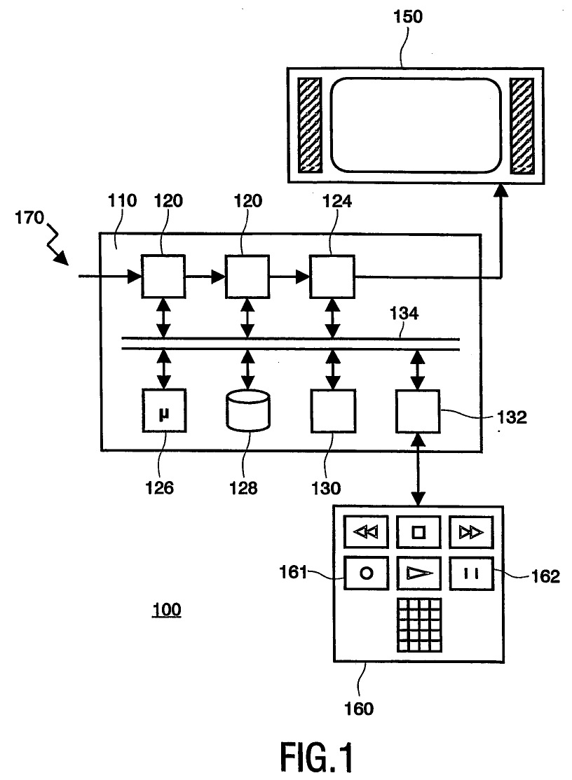

FIG. 1 shows an embodiment of the apparatus according to the invention;

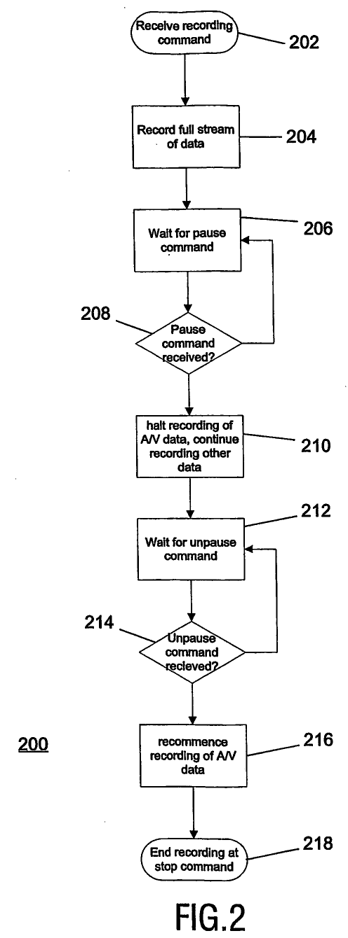

FIG. 2 shows a flow chart depicting an embodiment of the method according to the invention;

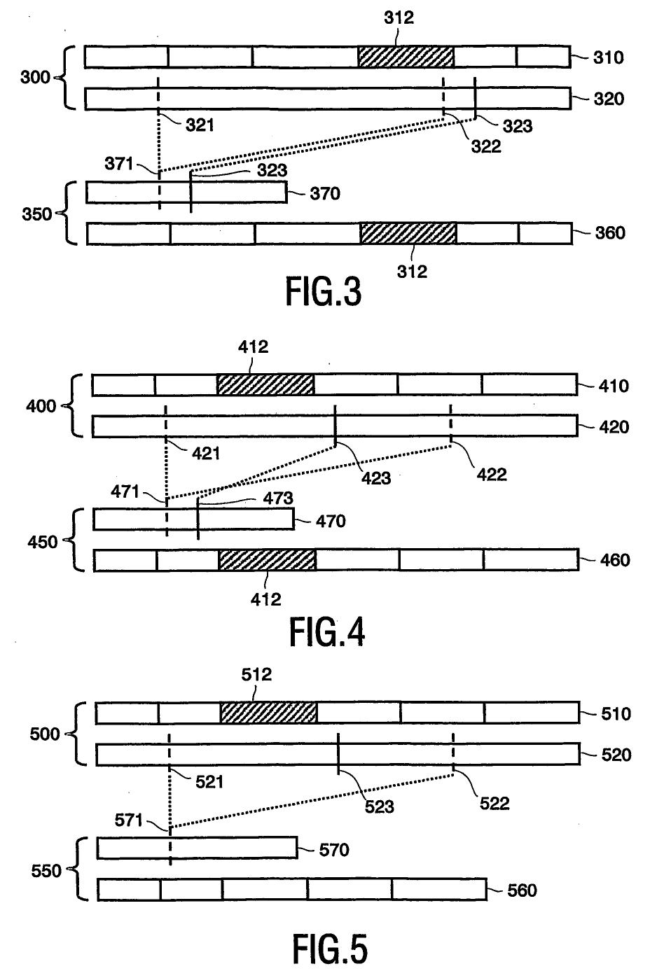

FIG. 3 shows streams of data with trigger/signal points elucidating an embodiment of the method according to the invention;

FIG. 4 shows streams of data with trigger/signal points elucidating a further embodiment of the method according to the invention; and

FIG. 5 shows streams of data with trigger/signal points elucidating another embodiment of the method according to the invention.

FIG. 1 shows a consumer electronics system 100 comprising a video recorder 110 as an embodiment of the apparatus according to the invention, a TV-set 150 and a control device 160. The video recorder 110 is arranged to record streams of audio-visual data and interactive applications associated with these streams of audio-visual data carried by a signal 170.

To this end, the video recorder 110 comprises a receiver 120 for receiving the signal 170, a de-multiplexer 122, a video processor 124, a microprocessor 126 for controlling components comprised by the video recorder 110, a storage device 128, a programme code memory 130, a user command receiver 132 and a central bus 134 for connecting components comprised by the video recorder 110.

The receiver 120 is arranged to tune in to a television channel and derive data of this television channel from the signal 170. The signal 170 can be received by any known method; cable, terrestrial; satellite or any other method of distributing audio-visual data. The signal 170 can even be derived from the output of another consumer electronics apparatus.

In the preferred embodiment, the data derived from the signal 170 complies with the DVB standard and carries MHP data. DVB is the European standard for digital video broadcasting and MHP—multimedia home platform—is a standard for interactive applications on the DVB platform. More information can be found on http://www.dvb.org.

As will be apparent to any person skilled in the art, the data derived from the signal 170 may just as well comply with another standard for digital video distribution like DASE. In yet a further embodiment, the data received is analog. In that case, the receiver 120 comprises an analog-to-digital converter for converting the analog data to digital data.

The data derived from the signal 170 and selected by the receiver 120 is transferred to the de-multiplexer which is arranged to split the received data into a stream of audio-visual data and data related to interactive applications or other meta-data related to the stream of audio-visual data. In the course of the description, the latter data will be referred to as interactive data, although the invention is not limited to this.

The stream of audio-visual data may be further processed by the video processor 124 in order to provide a signal compliant with the input standard of the TV-set 150 for reproduction of the audio-visual data on the TV-set 150. The stream of audio-visual data may just as well be stored in the storage device 128 for later reproduction, depending on user input commands.

In the preferred embodiment, the storage device 128 is a harddisk drive. However, as will be recognized by any person skilled in the art, the storage device 128 may just as well be an optical disk, a solid state memory or any other kind of storage device.

The interactive data derived by the de-multiplexer 122 is processed by the microprocessor 126 or stored in the storage device 128 for later processing. When the interactive data is processed, the output is sent to the video processor 124 for multiplexing it with the audio-visual data for reproduction by the TV-set 150.

Operation of the video recorder 110 is controlled by the microprocessor. This is done upon receiving commands from a user through control device 160, which command is received by the user command receiver 132. This is also done upon receiving a command or programme code from the program code memory 130.

Control data, audio-visual data and interactive data flow from the various components of the video recorder 110 over the central bus 134 or by direct links between the components.

In operation of known video recorders, a user is enabled to record a stream of audio-visual data like, for example, a television program. In this process, the data selected by a built-in tuner is stored in a storage device like tape or DVD+RW. In the simplest embodiment, this operation is started by pressing a ‘record’ button on a control device of the video recorder.

When applying this method straightforward to the video-recorder 110, it would mean that data received by the receiver 120 would be stored in the storage device 128. In this way, a stream of multiplexed audio-visual and interactive data is stored.

During the recording process, a pause button 162 can be pressed to suspend recording of the data. When this process would be suspended, using a method according to the prior art, storage of audio-visual data as well as interactive data is suspended. This is because the interactive data is multiplexed with the audio-visual data.

However, when during suspension of the recording process, interactive data is received that may be used by an interactive application that is run during reproduction of audio-visual data that is recorded after re-commencing the recording process, this may lead to problems because data of the application is missing.

Therefore, the invention proposes to keep recording the interactive data—or any other data other than audio-visual data—when the recording process is suspended and to suspend only the recording of audio-visual data. Of course, this implies that the received data has to be parsed or de-multiplexed first in audio-visual data and interactive data

A preferred embodiment of the method according to the invention will be described with reference to FIG. 1, FIG. 2 and FIG. 3. FIG. 2 shows a flow chart 200 representing an embodiment of the method according to the invention. FIG. 3 shows received data 300 and recorded data 350, both comprising a stream of audio-visual data and interactive data.

The process starts by receiving a recording command at a starting point 202. In the simplest embodiment, this operation is started by pressing a ‘record’ button 161 on the control device 160. Of course, other ways of starting the recording processes are known and can be applied without departing from the scope of the invention.

Subsequently, all received data 300 from a channel to which the receiver 120 is tuned in is recorded, i.e. stored in the storage device 128 during a process step 204. The received data 300 is built up from received interactive data 310 and received audio-visual data 320. The interactive data 310 is grouped as an object carousel, whereas the audiovisual data 320 is provided as a stream.

In the process step 204, the interactive data is stored as stored interactive data 260 and the received audio-visual data 320 is stored as stored audio-visual data 370.

While recording the data, the video recorder waits for an input command in a waiting loop comprising a waiting step 206 and a decision 208. When the command received is no pause command, the process stays in the loop and goes to the waiting step 206 again. When the command received is a pause command, the flowchart 200 continues to a process step 210.

In the process step 210, the recording of the received audio-visual data 320 is halted. Referring to FIG. 3, this is indicated by a first mark 321 in the received audio-visual data 320. However, the recording of the interactive data is continued.

The process step 210 is followed by another waiting loop, comprising a waiting step 212 in which the video recorder 110 waits for a command to continue the recording process that was started at the starting point 202, and further comprising a decision 214 in which the input command is checked.

When the input command is an unpause command, the process depicted by the flowchart 200 continues by recommencing the recording of the received audio-visual data 320 in a process step 216. The moment of recommencing the recording of the received audio-visual data 320 is indicated by a second mark 322.

The result of this process is that the stored audio-visual data 370 has a discontinuity indicated by a third mark 371 and that the stored audio-visual data 370 is less than the received audio-visual data 320, as indicated in FIG. 3. The stored interactive data 360 is the same as the received interactive data 310. During the recording process, redundancy caused by the carousel nature of the received data may be removed, but essentially, the stored interactive data comprises the same information as the received interactive data.

Advantages of the use of this method will become apparent from the following description. The received audio-visual data comprises a trigger point 323 for the start of an interactive application. The data for this application is comprised in an object transmitted in a carousel 312; other blocks in the received interactive data 310 indicate other versions of carousels or other objects.

When together with suspending recording of the received audio-visual data, the recording of the received interactive data would be suspended as well, the information in the carousel 312 would not be fully recorded. This would lead to problems when reproducing the television program from the storage device 128. When the TV-set 150 or the video recorder 110 encounters the trigger point 323, it tries to execute an application of which data is comprised in the carousel 312. However, when the carousel 312 is not fully recorded, this would lead to problems. These kinds of problems are solved by the method according to the invention.

The recording process is ended by a stop command in a terminator 218. It will be apparent to any person skilled in the art that the recording might be stopped all along the process depicted by the flowchart 200 at a stop command. For reasons of clarity, however, this has not been indicated in the flowchart 200.

Further embodiments of the invention will be described with reference to FIG. 4 and FIG. 5.

FIG. 4 shows received data 400 comprising received interactive data 410 and received audio-visual data 420. The received interactive data comprises a carousel 412. The received audio-visual data comprises trigger point 423 at which an application is started of which data is comprised in the carousel 412.

FIG. 4 further shows stored data 450 comprising stored interactive data 460 and stored audio-visual data 470. The stored data 450 is a result of recording the received data 400, halting the recording process at the point indicated by a first mark 421 and recommencing the recording process at a point indicated by a second mark 422, leading to a discontinuity in the stored audio-visual data 470 indicated by a third mark 471.

Due to the pause process, the trigger point 423 is not recorded. This may be all right, but may just as well lead to inconsistency of other applications that will be executed, because their execution is dependent on the execution of the application triggered by the trigger point 423.

Therefore, it may be desirable to execute the application triggered by the trigger point 423 anyway during reproduction of the stored data 450. To make this happen, the trigger point 423 is translated to a shifted trigger point 473 in the recorded audio-visual data. Preferably, the shifted trigger point 473 is inserted after the discontinuity indicated by the third mark 471.

In a further embodiment of the invention, execution of an application, which is signalled to execute during the part of the recording that is paused (that is, of which audio-visual data is not stored), is not desirable. For example, when the application is signalled to execute at a point half an hour or even more back in time from the point where the unpause command is given, it is likely that it is related to another program than the program that is recorded when giving the unpause command. It would be inconvenient for a user to be presented with an application related to a first program while viewing a second program.

When the execution of such an application is not desirable, the data does not have to be recorded either. FIG. 5 shows received data 500 comprising received interactive data 510 and received audio-visual data 520. The received interactive data comprises a carousel 512. The received audio-visual data comprises a trigger point 523 at which an application is started of which data is comprised in the carousel 5 12.

FIG. 5 further shows stored data 550 comprising stored interactive data 560 and stored audio-visual data 570. The stored data 550 is a result of recording the received data 500, halting the recording process at the point indicated by a first mark 521 and recommencing the recording process at a point indicated by a second mark 522, leading to a discontinuity in the stored audio-visual data 570 indicated by a third marker 571.

Due to the pause process, the trigger point 523 is not recorded. This means that the application that is signalled to start executing at a point 523 is not executed upon reproduction of the stored audio-visual data 570. In this example, the carousel 512 comprises only one application, which is the application of which execution is signalled to start at the point 523.

As mentioned, since the trigger point 523 does not occur in the recorded audio-visual data 570, it does not trigger that application. This means that storage of the carousel 512 is not necessary, because it does not comprise vital data for consistency of applications related to the stored audio-visual data 570. Therefore, according to a further embodiment of the invention, the data carousel 512 is deleted after the recording process. This is advantageous, because less storage space is used.

As will be apparent to any person skilled in the art, many variations of the preferred embodiments described are possible without departing from the scope of the invention.

For example, the audio-visual data may be presented in an analog format like PAL or NTSC and the data other than audio-visual data may be teletext. Also, the other data may comprise content description data like MPEG-7 or TV-Anytime.

Furthermore, the audio-visual data and the data other than the audio-visual data associated with said audio-visual data do not necessarily have to be multiplexed; they may just as well be received through separate channels. For example, the audio-visual data is received via a cable, whereas the other data is received via the internet through a DSL connection. For this purpose, an additional receiver is needed, but the de-multiplexer can be dispensed with.

In the preferred embodiment, the apparatus according to the invention is a dedicated video recorder. A further embodiment of the apparatus according to the invention may just as well be a programmed multi-purpose personal computer, conceived to perform the method according to the invention. In this further embodiment, the program code memory 130 (FIG. 1) is a computer program product like a CD-ROM, a DVD-ROM or a hard disk.

As described here, the pause command is initiated by a user pressing a pause button. However, in yet a further embodiment of the invention, the pause command is given by an embodiment of the apparatus according to the invention. This may be because meta-data of the received data indicates that the content of the audio-visual data has changed and is not desired by a user (heavy violence, discrimination).

In the description of the preferred embodiments, embodiments have been shown where there is a trigger point in the stream of audio-visual data for triggering the execution of an application. However, this does not mean that the trigger point is necessarily incorporated in the stream of audio-visual data The stream may be accompanied by a table with references to the stream, indicating at which point in the reproduction process an application should be run. During reproduction of the stored data, the table is processed and at a point at which an application should be run, the application is signalled to execute. The invention may be summarised as follows:

State-of-the art video recorders are equipped with a pause function. This function may be used in the play and record mode. When used in the record mode, no data is recorded. This is all right when only audio and/or video are recorded. However, when other data like interactive applications are recorded as well, this may lead to problems when the recording of an application is interrupted and this application is called upon in a video fragment that is recorded after resuming recording of audio and/or video.

An embodiment of the invention proposals only to suspend recording of audio and/or video when the record function is suspended using a pause function. In this way, recording of other data is continued.

1. A method of storing a stream of data received from a source in a memory, the stream of data comprising a stream of audio-visual data and other data, the method comprising the steps of:
(a) storing the stream of data in a memory; and
(b) receiving a pause command; characterized in that the method further comprises the steps of:
(c) pausing the storage of the stream of audio-visual data upon reception of the pause command; and
(d) continuing the storage of the other data.

2. Method as claimed in claim 1, wherein the other data is multiplexed with the stream of audio-visual data and the method further comprises the step of parsing the stream of data.

3. Method as claimed in claim 2, wherein the data in the stream is split into the stream of audio-visual data and other data, and the audio-visual data is stored apart from the other data in the memory.

4. Method as claimed in claim 1, wherein the other data comprises interactive applications that use trigger points in the stream of audio-visual data as input and wherein the method further comprises the steps of.
(a) receiving an unpause command;
(b) re-commencing the storage of the stream of audio-visual data upon reception of the unpause command; and
(c) shifting at least one trigger point that is present in the stream of audio-visual data that is received while storage of the stream of audio-visual data is paused towards a point in the stream of audio-visual data that will be stored after re-commencing the storage of the stream of audio-visual data.

5. Method as claimed in claim 1, wherein the other data comprises interactive applications that are run during reproduction of the stream of audio-visual data and the method further comprises the step of deleting applications that are not run during reproduction of the stream of audio-visual data that is stored in the memory.

6. Method as claimed in claim 1, wherein the stream of data is a DVB transport stream.

7. Method as claimed in claim 1, wherein the other data comprises applications according to the MHP standard.

8. Method as claimed in claim 1, wherein the pause command is generated by a processing unit, comprised by an apparatus conceived to carry out the Method as claimed in claim 1.

9. Method as claimed in claim 1, wherein:
(a) the other data comprises redundant information; and
(b) during pausing the storage of the audio-visual data, the redundant information in the other data is removed while storing the other data.

10. An apparatus for storing a stream of data received from a source in a memory, the stream of data comprising a stream of audio-visual data and other data, the apparatus comprising:
(a) means for receiving a memory to store the stream of data;
(b) means for receiving a pause command; and
(c) a central processing unit characterized in that the central processing unit is conceived to:
(d) pause a process of storing the stream of audio-visual data upon reception of a pause command; and
(e) continue the storage of the other data while the process storing of the stream of audio-visual data is paused.

11. A programmed computer, characterized in that the computer is programmed to perform the Method as claimed in claim 1.

12. A computer program product for programming a computer enabling the computer to perform the Method as claimed in claim 1.
